(19) United States
(12) Patent Application Publication
(10) Pub. No.: US 2020/0011407 A1
(43) Pub. Date: Jan. 9, 2020

(54) Alignment Bearing for Axle Assemblies

(71) Applicant: Donald Lane Bair, La Mesa, CA (US)

(72) Inventor: Donald Lane Bair, La Mesa, CA (US)

(21) Appl. No.: 16/029,512

(22) Filed: Jul. 6, 2018

(51) Int. Cl. F16H 48/38; F16H 48/06; F16H 57/08; F16C 19/06

(52) U.S. Cl. CPC F16H 48/38; F16H 48/06; F16H 2057/085; F16C 19/06; F16H 57/08

(57) ABSTRACT

A precision cantilever bearing assembly to align the output hubs of an axle assembly which includes a cantilever bearing positioned in one hub bore. The cantilever bearing has an axially extending bore. A shaft plug having an axially extending bore is positioned in the other hub bore. A shaft is positioned in and rotates and counter rotates in the cantilever bearing axially extending bore and is fixed in the shaft plug bore to facilitate alignment of the hubs.

### CROSS-REFERENCE TO RELATED APPLICATIONS

This application claims the benefit of U.S. Provisional Application No. 62/529,441, entitled “A Power Train-Output Hub Alignment Assembly,” filed Jul. 6, 2017, and U.S. Provisional Application No. 62/674,104, entitled “A Power-Train Output Hub Assembly,” filed May 21, 2018, the disclosures of which are hereby incorporated herein by reference.

### FIELD OF THE INVENTION

This invention relates to drive axles and more particularly to bearing assemblies for alignment of drive axles such as in Polaris ATV/UTV/ROV off highway front drive axles, lawn mowers and small tractors.

### BACKGROUND OF THE INVENTION

It is known that terrain generated impulse loads and poor lubrication can cause alignment problems on front drive axle assemblies on Off Highway Vehicles such as the Polaris ATV/UTV/ROV. Said Vehicles include an alignment bushing in their front differentials which have an operator selectable speed sensitive-electro mechanical overrunning clutch system. Sprag rollers engage when four wheel drive mode is selected and the rear wheels over-speed the front, when overspeed ceases engagement ceases.

FIGS. 1A-E show a prior art Polaris four wheel drive (4WD) vehicle front axle assembly/differential including, output hubs 10, a bearing 12, and an alignment bushing 16, a sprag cage 26, sprag rollers 27, a ring gear 28 having grooves 28a, a differential case cover 20, case seals 20a, a differential case body or housing 21, case seal 20b, an armature 22, an armature plate 23, an armature plate tab 23a, a torsion spring retainer 24, a torsion spring 25, In this vehicle, the front differential is geared to run more slowly than the rear wheels, and power is transferred to the front wheels only when 4WD is selected and the rear wheels spin or over-speed the front wheels. When two wheel drive (2WD) is selected, sprag rollers 27, maintain their equilibrium positions in ring gear grooves 28a (FIG. 1C), and power cannot normally be transferred to the front wheels.

When 4WD is selected, electrical current is sent to the armature 22, creating a magnetic field which slows the armature plate 23. The armature plate 23 is drivingly connected to the sprag cage 26 by the armature plate tabs 23a. This drag re-positions the sprag cage 26 and sprag rollers 27 in relation to the ring gear grooves 28a, such that when over-speed occurs, the sprag rollers 27 are wedged into the ring gear grooves 28a between drive hubs 10 and ring gear 28 (FIG. 1D). This event transmits power to the vehicle's front wheels. When over-speed stops, power transfer stops. The same event occurs under the same conditions in reverse. Torsion spring retainer 24 and torsion spring 25 reset the position of sprag cage 26 after 4WD over-speed.

For reliable functioning, the sprag rollers 27 must be in precise parallel alignment to the ring gear grooves 28a. When alignment bushing 16 is degraded and output hubs 10 are misaligned, wobbling or vibrating, the sprag rollers 27 will not align or will be knocked out of alignment, thus either resulting in a partial roller engagement or prevention of the transfer of power to said front axle when 4WD is selected.

In addition, in 2WD or 4WD, because of vibration, one or more sprag rollers 27 may wedge, creating an un-commanded engagement event, possibly causing the sprag cage 26 to break, causing loss of function. Vibration and misalignment will also damage or cause failure of the sprag cage 26, causing loss of function. If the output hubs 10 are excessively misaligned or vibrating, differential fluid may seep out of case output seals 20a, and sand, mud and water may seep in, possibly causing damage and failure. Our testing shows that when said output hubs 10 are wobbling more than +−0.015 inches that leakage and intrusion of sand, mud and water begins to occur. And because the output hubs are above the lubricant level in the differential case they often quickly degrade or seize because of lack of lubricant.

It is understood that the alignment bushing 16 needs to maintain alignment within a tolerance range to maintain function and prevent damage. However, alignment bushings quickly degrade, partially because of design caused lubrication issues, partially because of relatively low quality material, (plastic deformation) and particularly because of a poor Length to Diameter ratio L/D, known to the art. FIG. 1E shows output hubs 10, alignment bushing 16, and dimensions L and D. The L/D ratio can be calculated by diving the length of the protruding alignment bushing by its diameter. In one prior art vehicle the (“non-turbo”), alignment bushing 16 has an approximate supported length of 0.425″ and an approximate diameter of 1.3″ which equals an L/D of 0.327. In another prior art vehicle, (“turbo”) the alignment bushing 16 has an approximate supported length of 0.425″ and an approximate diameter of 1.56″ which equals and L/D of 0.272. It can be understood that the smaller the L/D the less durable the device or part and because of poor materials, lubrication and L/D ratios that the OEM alignment bushings have short lives.

Impulse loads can quickly degrade alignment bushings 16, causing output hubs to wobble, vibrate, and misalign. These events cause degradation in an increasingly destructive cycle that can cause several potentially dangerous failures, such as seizure of the alignment bushing output hub assembly which may prevent differentiation and cause handling issues, vibration and misalignment of the sprag rollers possibly preventing engagement of four wheel drive, failure of the sprag cage, possible spontaneous unselected violent engagement of the front differential and distortion to case seals causing loss of fluid and ingress of water and sand. When wobble reaches approximately 0.015 inches, fluid loss and material and water intrusion begins to occur. Any of the preceding events can lead to complete mechanical failure of the differential. An alignment bearing with higher material quality, a longer bearing surface, better engineered L/D ratios and provisions for improved lubrication can greatly increase durability and thus some of the functional issues of such vehicle front axle assemblies.

A durable, precision bearing assembly would increase the life and functionality of the front axle assemblies of this and similar vehicles.

### SUMMARY OF THE INVENTION

The present invention is a precision plain bearing and hub alignment assembly for use in an axle assembly with drive hubs. The bearing and hub alignment assembly is securely positioned in axially extending bores of opposing drive hubs and includes a cantilever bearing positioned in one hub bore. The cantilever bearing has an axially extending bore. A shaft plug is positioned in the other hub bore. A shaft is securely held within the shaft plug bore. The shaft has a close tolerance in the cantilever bearing bore to allow rotation and to facilitate alignment of the hubs.

### BRIEF DESCRIPTION OF THE DRAWINGS

FIG. 1A is an exploded view of a prior art front differential.

FIG. 1B is a side view of certain components of the assembly of FIG. 1A.

FIGS. 1C,1D and 1E are a sectional side views of certain components of FIG. 1A.

FIG. 1 is a sectional exploded view of the prior art output hub assembly of FIG. 1A.

FIG. 2 a partially sectional assembled view of the output hub assembly of FIG. 1.

FIGS. 3A, and 3B are sectional assembled and exploded side views of the output hub assembly of the present invention.

FIG. 4 is an exploded perspective view of the bearing assembly of FIG. 3A.

FIG. 5 is a perspective view of a subassembly of the bearing assembly of FIG. 3A.

FIG. 6 is a perspective view of the assembled bearing assembly of FIG. 3A.

FIG. 7 is an exploded sectional view of a first alternative embodiment of the bearing assembly of the present invention.

FIG. 7a is an enlarged sectional view of the lower portion of the cantilever bearing of FIG. 7.

FIG. 8 is a partially exploded sectional view of the embodiment of FIG. 7.

FIG. 9 is a sectional view of the assembled embodiment of FIG. 7.

FIG. 10 is an exploded sectional view of a second alternative embodiment of the bearing assembly of the present invention.

FIG. 11 is a partially exploded sectional view of the embodiment of FIG. 10.

FIG. 12 is a sectional view of the assembled embodiment of FIG. 10.

FIG. 13 is an exploded sectional view of a third alternative embodiment of the bearing assembly of the present invention.

FIG. 14 is a partially exploded sectional view of the embodiment of FIG. 13.

FIG. 15 is a sectional view of the assembled embodiment of FIG. 13.

FIG. 16 is an exploded perspective view of a fourth alternative embodiment of the bearing assembly of the present invention.

FIG. 16a is a partially exploded perspective view of the embodiment of FIG. 16.

FIG. 16b is a perspective view of the assembled embodiment of FIG. 16.

FIG. 17 is an exploded sectional view of a fifth alternative embodiment of the bearing assembly of the present invention.

FIG. 18 is a sectional view of the assembled embodiment of FIG. 17.

FIG. 19 is a sectional view of an integral shaft plug of the present invention.

FIG. 20 is a graph showing output hub play vs. vehicle driving distance.

### DESCRIPTION OF PREFERRED EMBODIMENTS

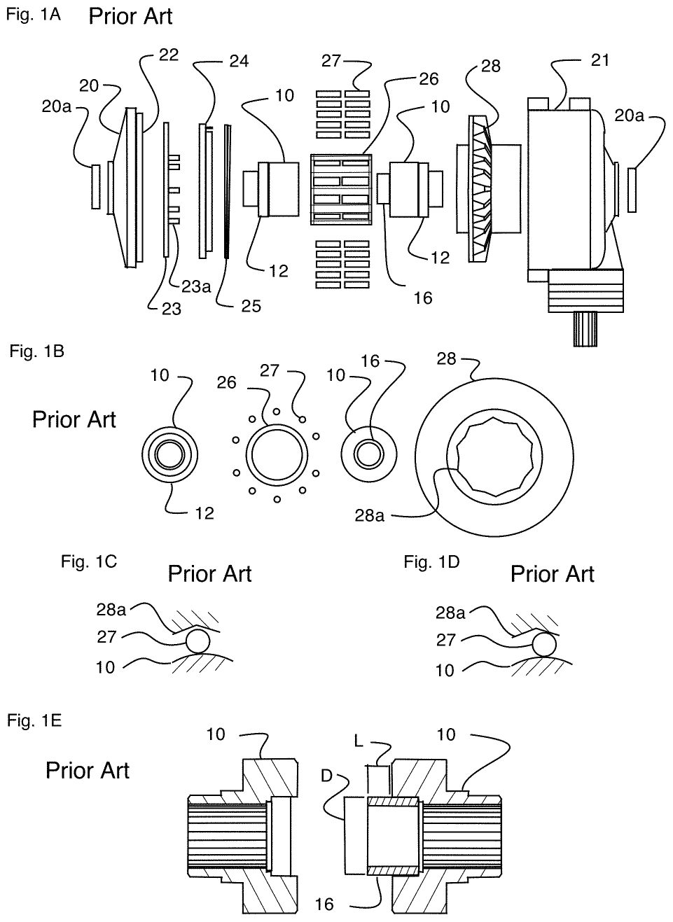

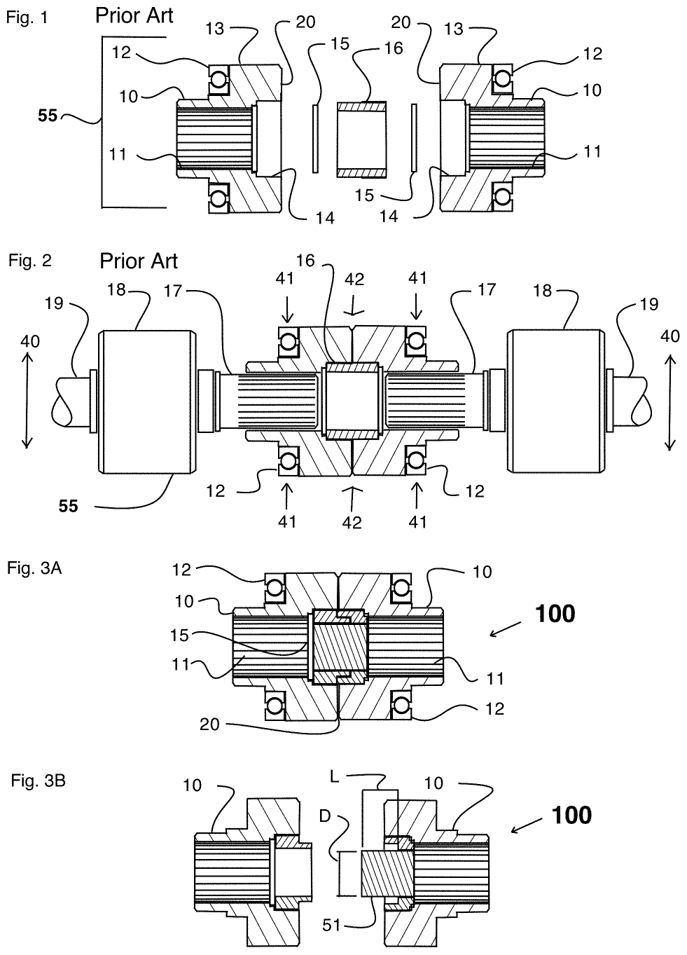

FIG. 1 shows a prior art output hub assembly 55 of a Polaris ATV/UTV/ROV front axle assembly. Hub assembly 55 includes output hubs 10 having splined bores 11, output hub bearings 12, sprag roller engagement surfaces 13, alignment bushing bores 14, axle bore plugs 15, alignment bushing 16 and output hub faces 20. The bore plugs 15 are solid discs as is well known in the art. The components 10, 11, 12, 13, 14, 15, on the left and right sides of the assembly 55 are identical and interchangeable.

Referring to FIG. 2, the output hub assembly 55 includes axle assemblies including CV joints 18 drivingly engaged with CV joint axle shafts 17 and axle shafts 19. CV joint shaft 17 is driven by splined bore 11. External bump-droop-plunge load force 40, pivot point 41, and alignment bushing bump-droop-plunge load force 42 are also shown. Bump-droop-plunge load forces are terrain generated G forces and CV axle plunge forces acting on alignment bushing 16. It is understood that OEM alignment bushing 16 is press fit into the bore 14 of one output hub 10 and rotates in the bore 14 of the other output hub 10.

Front differential case bearings 12, act as pivot points 41 for external bump-droop-plunge load forces 40 which occur as a vehicle travels through rough terrain. External bump-droop-plunge load forces 40 are transferred into assembly 55 through pivot points 41 and act upon the assembly 55 and thus the alignment bushing 16. When external bump-droop-plunge load forces 40 exert a downward force on a CV joint axle shaft 17, CV joint 18, and axle shaft 19, the assembly 55 is pushed upwards and the alignment bushing 16 has to react to the alignment bushing bump-droop-plunge load force 42. These external forces during bump-droop and significant plunge loads from full suspension travel cause the degradation of the alignment bushing 16, leading to the failure modes discussed above.

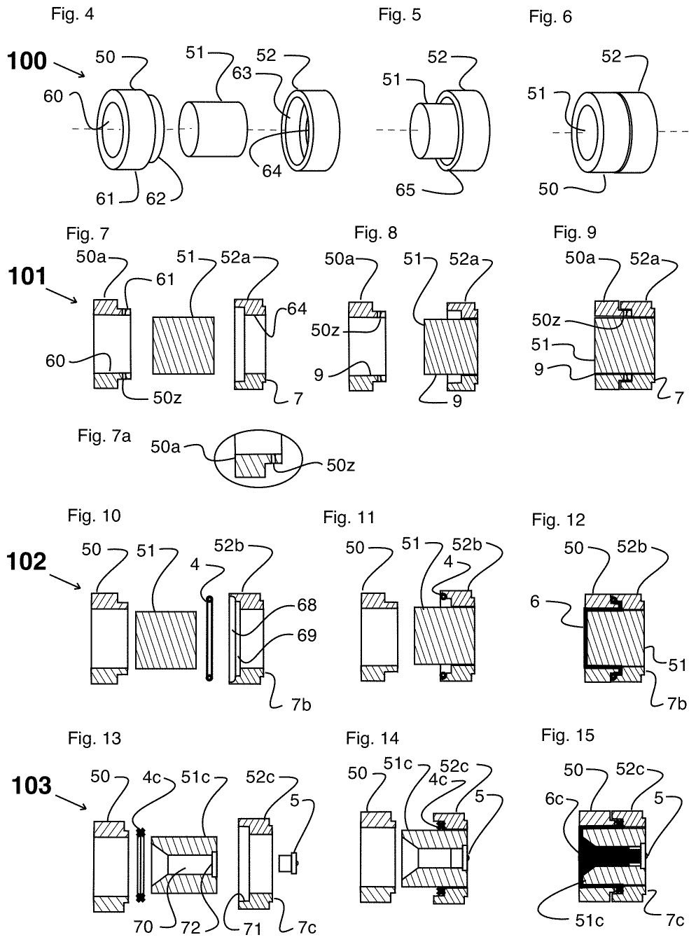

FIGS. 3A, 3B and 4-6 show a hub and bearing assembly 100 of the present invention. The hubs 10 are identical to the prior art hubs 10 of FIGS. 1A, 1B, 1E, 1 and 2. The alignment bushing 16 of FIGS. 1 and 2 has been replaced. It can be understood that the OEM non-turbo and turbo alignment bushings can be replaced by embodiments of the present invention that have dimensions such to conform to the dimension of the bores 14 of the output hubs 10. FIG. 3B explains the L/D ratio of the present invention and show the output hub 10 with assembly 100. The L/D ratio can be calculated by diving the length of the protruding shaft 51 by its diameter. The non-turbo assembly, has an approximate supported length, of 0.750″ and an approximate diameter of 0.875″ which equals an L/D of 0.857. The turbo assembly, has an approximate supported length, of 0.750″ and an approximate diameter of 1.00″ which equals and L/D of 0.750. It can be understood that the present invention has superior durability because of its better L/D ratios. The assembly 100 includes a cantilever bearing 50 having a cylindrical internal bore 60 and cylindrical stepped outer surfaces 61 and 62, and a shaft 51. The shaft plug 52 has stepped internal bores 63 and 64 and a radially extending annular rim 66. The bearing areas of the assembly are the cantilever bearing bore 60, the exterior of shaft 51 in contact with the bore 60. Bearing 50 and shaft plug 52 having an external diameter substantially the same as the diameter of the bore 14 of output hubs 10, which are consistent with the tolerances of an interference fit. The diameters of shaft 51 and the bore 60 of bearing 50 are consistent with the tolerances of a precision close tolerance plain bearing, which allows shaft 51 to rotate within the bore of bearing 50. The diameters of bore 64 of shaft plug 52 and shaft 51 are consistent with the tolerances of an interference fit. The output hub faces 20, FIGS. 1 and 3, accept the thrust loads.

Shaft plug 52 holds shaft 51 fixedly in the bore of an output hub 10 so that shaft 51 and cantilever bearing 50 can provide mechanical alignment and counter rotation of both said output hubs 10. Cantilever bearing 50 holds shaft 51 fixedly in the bore 14 of the opposing hub 10 and allows counter rotation. All of the alternative embodiments of the present invention discussed herein are cantilever type precision close tolerance plain bearing assemblies which have similar bearing areas, tolerances and superior L/D ratios. The shaft plug 52 is designed to also prevent the differential case from losing lubricant.

FIG. 5 shows shaft 51 and shaft plug 52, with the shaft 51 pressed into shaft plug 52. Alternatively, shaft 51 and shaft plug 52 can be made as one integral part, such as a single machining or forging. The part of the exterior of shaft 51 that is in contact with the interior of the bore 64 of cantilever bearing 50 is a bearing surface. The output hub faces 20 accept the thrust loads. FIG. 6 shows the assembled view cantilever bearing 50, shaft 51, shaft plug 52.

A first alternative embodiment 101 shown in FIGS. 7-9 and 7a. Introducing oil hole 50z in bearing 50a and a modified shaft plug 52a having shaft plug ring 7. The shaft plug ring 7 is an annular extension on the shaft plug 52a. The cantilever bearing 50a includes two lubrication ports 50z. See closeup, FIG. 7a. When an embodiment of the present invention replaces a prior art OEM alignment bushing 16, the shaft plug ring 7 replaces axle bore plug 15 to provide sealing from the elements and to prevent loss of lubricating fluid from the differential housing.

The load bearing areas are shown in FIGS. 8 and 9 (identified by reference number 9). The areas 9 include the interior of the bore of cantilever bearing 50a, the part of the exterior of shaft 51 contacted by the interior of the bore of cantilever bearing 50a. The output hub faces 20 of output hubs 10 accept the thrust loads. Load bearing areas 9 and 20 react the alignment bushing bump-droop-plunge load force 42. The bearing areas 9 and 20 are provided with lubricant that can be any synthetic, natural, dry or petroleum based oil, grease, lubricating fluid, powder, material or substance.

FIGS. 10-12 show a second alternative, sealed bearing embodiment 102 including a modified shaft plug 52b having a shaft plug ring 7b and stepped annular bores 68 and 69. An O-ring 4 is seated in bore 68 to seal lubrication areas 6. Embodiment 101 becomes a sealed bearing because lubricant 6 is captured by shaft 51 and shaft plug 52b, O-ring 4 and axle bore plug 15 (FIG. 1).

A third alternative embodiment 103 is shown in FIGS. 13-15, including a modified shaft 51c, shaft plug 52c and a grease fitting 5. The shaft 51c is hollow, having a stepped bore 70 with a second annular bore 72 to accommodate grease fitting 5. The shaft plug 52c includes a bore 71 to accommodate an X-ring 4. Embodiment 102 is a sealed bearing also including a flush grease fitting 5. The grease fitting 5 sealingly engages shaft bore 70 and second annular bore 72. FIG. 15 shows lubricant 6c. X-rings and O-rings are equivalent types of sealing devices known to the art and any type of applicable sealing device, material or substance may be used.

Embodiment 103 can be lubricated without removal from the differential housing through grease fitting 5 by the removal of the corresponding CV joint 18, CV joint axle shaft 17 and axle shaft 19. Of course, all embodiments of the invention can include similar grease fitting 5 or any other type of flush grease or lubrication fitting.

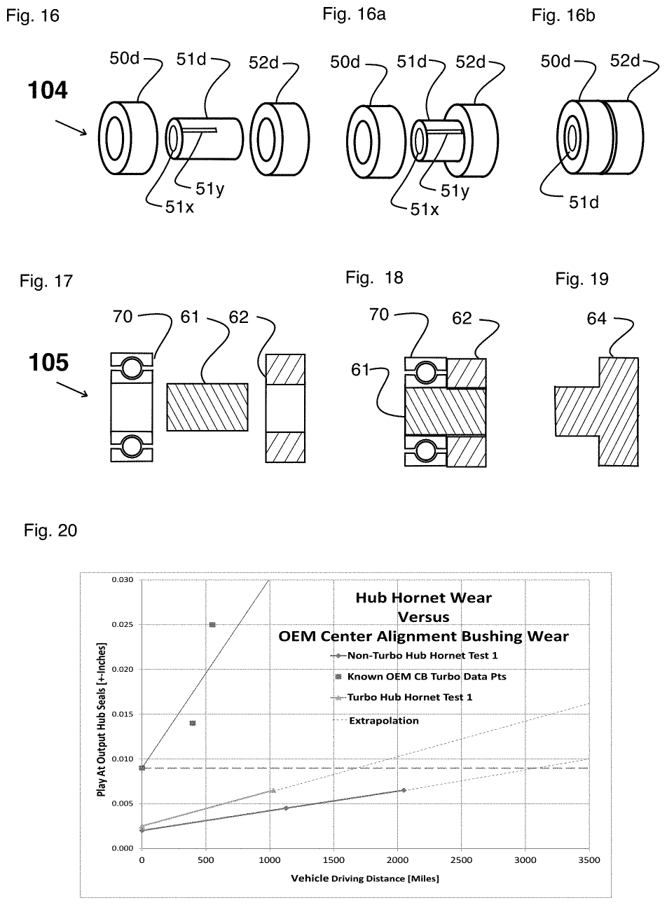

A fourth alternative embodiment 104 shown in FIGS. 16, 16a, and 16b, is a simple form of the present invention. Embodiment 104 includes a simple annular plain bearing 50d, a simple annular shaft plug 52d, and a hollow shaft 51d. Each of the bearing 50d and the shaft plug 52d is a simple annulus. The shaft 51d includes a cylindrical bore 51x and one or more lubricant slot 51y, which is cut into the outer surface of the shaft. Of course, a simpler form of the invention could include a solid shaft 51 or a hollow shaft without a lubrication slot. It is understood that shaft 51d has an interference fit with shaft plug 52d and the bore of bearing 50d has a close tolerance plain bearing dimension that allows shaft 50 to rotate within said bore.

A fifth alternative embodiment 105 is shown in FIGS. 17 and 18. The cantilever bearing 50 can be substituted for a roller bearing of any type, common roller bearing 70 shown. The shaft 61 is a solid shaft. The shaft plug 62 is a simple annular member. Shaft plug 62 may also be replaced with a second roller bearing of any type known to the art. Of course, other types of bearings may also be used, such as needle bearings, tapered roller bearings, deep groove roller bearings, ball thrust bearings, roller thrust bearings, plain bearings, ceramic bearings, journal bearings, without limitation. Embodiment 105 can use any combination of bearing types.

FIG. 19 shows an integral shaft-plug produced as a single part, for example, by machining or forging.

The embodiments of the present invention can be modified in general shape, size and configuration to conform to all vehicle sizes and variations. The invention is particularly suitable for use in ATV/UTV/ROV front differentials, but may be adapted for use in other vehicles or devices using a similar axle assembly.

The present invention is a cantilever type plain bearing assembly, consisting of a hardened precision ground shaft, and a hardened, precision machined shaft plug and bearing. The shaft may be pressed into said shaft plug to creating a subassembly which then is pressed into the bore of one output hub after removal of the axle bore plug. The bearing is then pressed into the bore of the other output hub and the shaft rotates in the bearing.

Embodiments of the present invention have better alignment tolerances after thousands of test miles than new OEM alignment bushings. FIG. 20 illustrates test results showing Output Hub Play versus Vehicle Driving Distance (miles). The graph shows test results using Polaris vehicles and Embodiment 100 of the present invention in both turbo and non-turbo versions. Testing shows that the Embodiment 100 of the present invention can sustain better than OEM alignment bushing tolerances under extreme testing conditions and for the life of a Polaris vehicle. In test cases new Polaris OEM alignment bushings had an average of +−0.012″ play and embodiment 100 had 0.0045″ play. Many Polaris OEM alignment bushings had +−0.028′ after approximately 500 to 1000 miles while embodiment 100 of the present invention had 0.007′ after 2000 miles. Wobble of output hubs at output hub seals of greater than +−0.015 inches will cause loss of fluid and said front differential will see intrusion from the elements. Our testing also shows that many racers are able to finish a race with a working front differential where in the past, without the present invention, they were not.

Embodiment 105 of the present invention consists of an annulus a shaft and an annulus, or an element and an element with an integral shaft or a bearing a shaft and a shaft plug that mounts said shaft fixedly in the bore of said Polaris OEM output hub.

All embodiments may be engineered with a longer bearing, superior L/D ratio and be precisely machined to known to the art tolerances for both precision plain bearings and interference fit tolerances, from high quality pre and or post machining hardened steel alloys and case hardened shafts, without limitation. The critical dimensions (bearing bore, shaft plug bore, and both bearing and shaft O.D.s) are machined to close tolerances, but within tolerances that can be consistently held by numerically controlled machines. The combination of the precision shafting tolerances and the practical machining tolerances of modern machines results in a product that can be consistently and economically manufactured to a very high level of quality. All embodiments including the annulus, cantilever bearing, bearing, shaft and shaft plug can be composed of any material, such as ceramic, metal alloys including 4100 and 4300 steels, chromium, stainless steel, nickel, titanium and copper, carbon or synthetic materials, without limitation.

All embodiments can be made by any process known to the art including machining, CNC machining, 3-D printing, milling, grinding, powdered metal forging or sintering etc. without limitation. All embodiments can use any type or configuration of a shaft as fluted, spiral ground, grooved, hollow, solid etc. All embodiments can be coated, sprayed, plated or covered by any industrial process known to the art, by any substance or material including chromium, titanium, nitride etc. to increase durability and hardness, without limitation. All embodiments can be coated, sprayed, plated or covered by any industrial process known to the art, by any substance or material, known to have lubricating qualities such as molybdenum, carbon, graphite, PTFE, Teflon, etc.

All embodiments of the present invention can be a sealed bearing as grease, oil or other lubricating fluids are held within its body by an O-ring or X-ring placed without limitation internally or externally to the bearing, shaft, shaft plug and by axle bore plug. It is understood that the O-ring or X-ring can have several different profiles including square and U, without limitation and said O-ring, X-ring, can be made from made from Silicone, Viton, Buna-N, EPDM etc. or any substance or material, known to the art without limitation. And any type of applicable sealing device, material or substance known to the art is hereby included by reference into this disclosure, without limitation.

All embodiments of the present invention can be used to replace both non-turbo and turbo OEM alignment bushings such as 16 and all embodiments can fit precisely within their bores 14 of the output hubs 10. It is understood that the higher material quality, better engineered and lubricated embodiments of the present invention can solve the degradation and thus the functional issues of many vehicles front axle assemblies.

The invention includes a method of repairing or improving a prior art axle assembly. For example, to modify the assembly disclosed in FIGS. 1 and 1A, the unit is first disassembled and the bearing 16 is discarded. A cantilever bearing 50 is press fit or otherwise fixedly secured into a bore 14 of one of the hubs 10. A shaft plug 52 is press fit or otherwise fixedly secured into the bore 14 of the other hub 10. One end of a shaft 51 is inserted into the bore 64 of shaft plug 52 in an interference fit and the other end of said shaft is inserted into the bore 60 of bearing 50 in a precision close tolerance plain bearing fit, so it can rotate and counter rotate, as described above. The unit is then reassembled. Similar methods would apply to all embodiments of the invention disclosed herein. Of course, this method includes the benefits of reducing the L/D ratio and improved lubrication.

The descriptions of specific embodiments of the invention herein are intended to be illustrative and not restrictive. The invention may be practiced otherwise than as specifically explained and illustrated without departing from its spirit or scope as defined by the appended claims.

What is claimed is:

1. An axle assembly comprising:
first hub rotatable about an axis of rotation, the first hub having an axially extending bore, a second hub rotatable about the axis of rotation, the second hub having an axially extending bore, and a hub alignment assembly positioned in the hub bores, the alignment assembly comprising:
a cantilever bearing positioned in the first hub bore, the cantilever bearing having an axially extending bore,
a shaft plug positioned in the second hub bore, the shaft plug including an axially extending shaft, the shaft frictionally engaged with the first hub bore to facilitate alignment of the first and second hubs.

2. An axle assembly as defined in claim 1 further comprising a first axle shaft drivingly engaging the first hub a second axle shaft drivingly engaging the second hub, the first and second axle shafts rotatable about the axis of rotation such that the first and second axle shafts and first and second hubs are axially aligned.

3. An axle assemble as defined in claim 1 wherein the shaft is press fit into the shaft plug.

4. An axle assembly as defined in claim 1 wherein the cantilever bearing has an outer surface and wherein a radial bore extends from the first hub bore radially to the outer surface of the cantilever bearing.

5. An axle assembly as defined in claim 1 wherein the shaft plug includes a shaft plug ring extending away from the cantilever bearing.

6. An axle assembly as defined in claim 1 further comprising a seal between the cantilever bearing and the shaft plug.

7. An axle assembly as defined in claim 6 where in the seal is an O-ring.

8. An axle assembly as defined in claim 6 wherein the seal is an X-ring.

9. An axle assembly as defined in claim 1 wherein the shaft is hollow.

10. An axle assembly as defined in claim 1 further comprising an annular bore plug seated in the first hub adjacent the cantilever bearing.

11. An axle assembly as defined in claim 1 wherein the shaft includes an annular step, and wherein the assembly further includes a grease plug seated in the step.

12. An axle assembly as defined in claim 1 wherein the shaft plug and shaft are integrally forged.

13. An axle assembly as defined in claim 1 wherein the shaft has an outer surface and wherein the outer surface includes a slot.

14. An axle assembly as defined in claim 1 wherein at least one of the cantilever bearing and shaft plug is a simple annulus.

15. An axle assembly as defined in claim 1 wherein at least one of the cantilever bearing and shaft plug is a ball or roller bearing.

16. A differential assembly comprising a differential housing, first hub rotatable about an axis of rotation, the first hub having an axially extending bore, a first axle shaft drivingly engaging the first hub, a second hub rotatable about the axis of rotation, the second hub having an axially extending bore, a second axle shaft drivingly engaging the second hub, and a hub alignment assembly positioned in the hub bores, the alignment assembly comprising:
a cantilever bearing positioned in the first hub bore, the cantilever bearing having an axially extending bore,
a shaft plug positioned in the second hub bore, the shaft plug including an axially extending shaft, the shaft frictionally engaged with the first hub bore to facilitate alignment of the first and second hubs.

17. An axle assembly as defined in claim 16 wherein the shaft plug includes a shaft plug ring extending away from the cantilever bearing, wherein the shaft plug ring is seated in the second hub bore.

18. A bearing assembly for a differential, the bearing assembly comprising:
(a) an annular cantilever bearing having an inner bore and an outer cylindrical surface for positioning in a bore of a first axle hub, the outer surface having a reduced diameter cylindrical step,
(b) a shaft plug having an inner bore and an outer cylindrical surface for positioning in a bore of a second axle hub, the inner bore having an enlarged diameter cylindrical step,
(c) a shaft having a first end positioned in the cantilever bearing inner bore and a second end positioned in the shaft plug inner bore,
wherein the cantilever bearing reduced diameter cylindrical step is positioned within the shaft plug enlarged diameter cylindrical step.

19. A bearing assembly as defined in claim 18 wherein the shaft has an outer surface and the outer surface has a lubrication slot.

20. A bearing assembly as defined in claim 18 wherein the cantilever bearing reduced diameter cylindrical step includes a lubrication port extending from the cantilever bearing inner bore.
